(19) United States
(12) Patent Application Publication
(10) Pub. No.: US 2009/0092136 A1
(43) Pub. Date: Apr. 9, 2009

(54) SYSTEM AND METHOD FOR PACKET CLASSIFICATION, MODIFICATION AND FORWARDING

(75) Inventors: Sean F. Nazareth, Irvine, CA (US); Larry Osborne, Austin, TX (US); David Patrick Danielson, Daly City, CA (US); Leo Kaplan, Laguna Hills, CA (US); Daniel John Burns, Aliso Viejo, CA (US); Fabian A. Gomes, Irvine, CA (US)

Correspondence Address: BRAKE HUGHES BELLERMANN LLP;c/o CPA Global, P.O. Box 52050, Minneapolis, MN, 55402, US

(73) Assignee: BROADCOM CORPORATION, Irvine, CA (US)

(21) Appl. No.: 12/021,409

(22) Filed: Jan. 29, 2008

Related U.S. Application Data
(60) Provisional application No. 60/978,583, filed on Oct. 9, 2007.

(51) Int. Cl. H04L 12/56

(52) U.S. Cl. 370/392

(57) ABSTRACT

A system may include a processor that is arranged and configured to receive initial data packets from a data stream, to classify the initial data packets from the data stream and to populate one or more tables with information based on the classification of the initial data packets from the data stream. The system may include a bus in communication with the processor and an engine, in communication with the bus, that is arranged and configured to process subsequent data packets from the data stream using the information present in the one or more tables such that the subsequent data packets from the data stream bypass the processor.

### CROSS REFERENCE TO RELATED APPLICATIONS

This application claims the benefit of U.S. Provisional Application No. 60/978,583, filed Oct. 9, 2007, and titled “System and Method For Packet Classification, Modification and Forwarding”, which is hereby incorporated by reference in its entirety.

### TECHNICAL FIELD

This description relates to packet classification, modification and forwarding.

### BACKGROUND

Data packets may be communicated through wide area networks and local area networks. Devices may be used to connect one network with another network and/or to connect a network with one or more other devices. Data packets may be communicated through these devices.

### SUMMARY

The details of one or more implementations are set forth in the accompanying drawings and the description below. Other features will be apparent from the description and drawings, and from the claims.

### BRIEF DESCRIPTION OF THE DRAWINGS

FIG. 1 is an exemplary block diagram of a system for processing data packets.

FIG. 2 is an exemplary block diagram of an engine from FIG. 1.

FIG. 3 is an exemplary block diagram of a packet classifier module of FIG. 2.

FIG. 4 is an exemplary block diagram of a packet modifier module of FIG. 2.

FIG. 5 is an exemplary block diagram of a packet info RAM module of FIG. 4.

FIG. 6 is an exemplary block diagram of a portion of a packet modifier module of FIG. 2.

FIG. 7 is an exemplary block diagram of a packet forwarder module of FIG. 2.

FIG. 8 is an exemplary block diagram of a system for processing data packets.

FIG. 9 is an exemplary flow chart of a process for processing data packets.

### DETAILED DESCRIPTION

In general, a system may be used to route and bridge data packets that are communicated between networks and/or to route and bridge data packets that are communicated between a network and one or more devices. For example, a system may be used to route and bridge data packets that are incoming from a first network and outgoing to a second network. The system may include a processor that processes an initial flow of data packets and that configures rules and tables such that subsequent data packet processing may be handed off to an engine.

In one implementation, the engine may enable the classification, modification and forwarding of data packets received on wide area network (WAN) and/or local area network (LAN) interfaces. The engine may be a hardware engine such that the hardware engine enables the classification, modification and hardware routing of data packets received on WAN and/or LAN interfaces. One or more engines may be used in the system.

Using the engine to process the data packets may enable the data packet processing to be offloaded from the processor and enable the flow of data packets to be accelerated, thus increasing the throughput of the data packets. The engine may be configured to handle multiple data packet flows and to provide a variety of modification functions including network address translation (NAT), point-to-point protocol over Ethernet (PPPOE) termination and virtual local area network (VLAN) bridging.

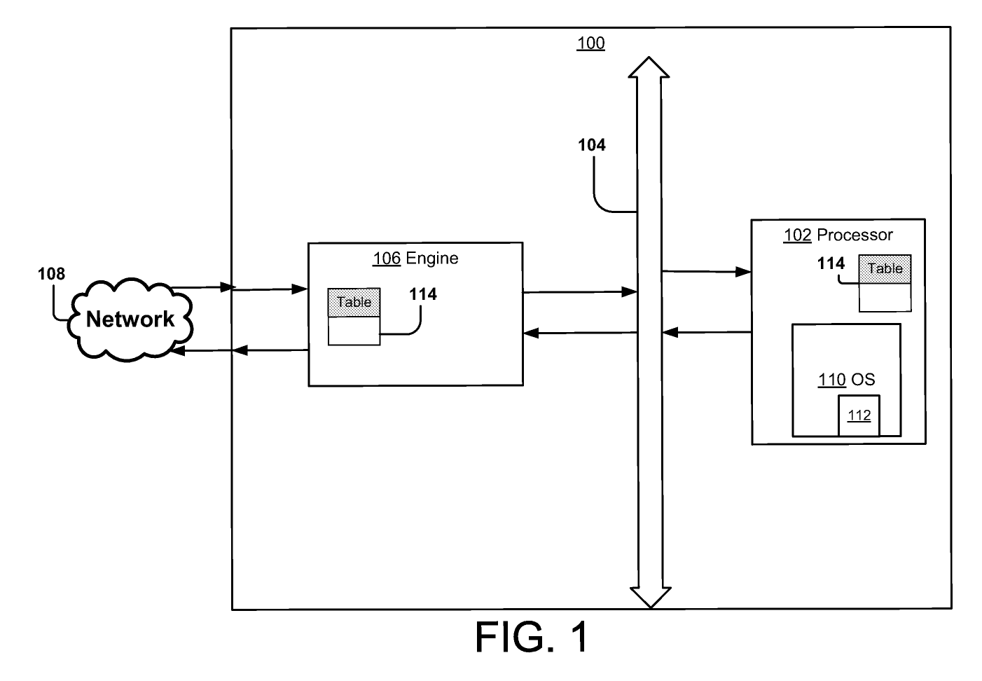

Referring to FIG. 1, a system 100 may be used for processing data packets. System 100 includes a processor 102, a bridge 104 that communicates with the processor 102 and an engine 106 that communicates with the bridge 104 and that communicates with the processor 102 using the bridge 104. A network 108 communicates with the system 100.

System 100 may be implemented on a single chip and used in multiple different devices and solutions. For example, system 100 may be a highly integrated single chip integrated access device (IAD) solution that may be used in gateways, routers, bridges, cable modems, digital subscriber line (DSL) modems, other networking devices, and any combination of these devices in a single device or multiple devices. System 100 may be configured to handle multiple data flows.

Network 108 may include one or more networks that communicate with system 100. For instance, network 108 may include multiple different networks that communicate with system 100. Network 108 may include a WAN, a LAN, a passive optical network (PON), a gigabyte passive optical network (GPON), and any other type of network. System 100 may provide an interface between different networks 108 to process upstream data packets and downstream data packets between the networks 108. Although FIG. 1 illustrates an incoming data path and an outgoing data path between the network 108 and system 100, there may be multiple different data paths and wired and wireless ports to communicate with different multiple networks 108.

Processor 102 may include a processor that is arranged and configured to process data packets. Processor 102 may be configured to process one or more streams of data packets. In one implementation, processor 102 may include a single threaded, single processor solution. Processor 102 may be configured to perform other functions in addition to data packet processing. Processor 102 may include an operating system (OS) 110. For example, operating system 102 may include Linux-based OS, a MAC-based OS, a Microsoft-based OS such as a Windows® OS or Vista OS, embedded Configurable operation system (eCos), VxWorks, Berkeley Software Distribution (BSD) operating systems, QNX operating system, or any other type of OS. Typical operating systems, such as the example operating systems discussed above, may include a data packet processing stack 112 for processing data packets that are communicated with a network.

In one implementation, the data packet processing for system 100 may be handled solely by processor 102. For instance, processor 102 may be configured to process data packets such that the data packet processing stack 112 is bypassed. For instance, the processor 102 may be configured to inspect the incoming data packets and to classify the data packets to populate one or more tables 114. The incoming data packets may be modified and forwarded to one or more destinations. Once the processor 102 has inspected and classified the initial data packets of a stream, then the data packet processing stack 112 may be bypassed by using the information in the tables 114 that were populated with information from the initial data packets. Bypassing the data packet processing stack 112 may increase and accelerate the speed at which the data packets are processed. For instance, the processing of data packets may be increased by 2.5 times by bypassing the data packet processing stack 112. Bypassing the data packet processing stack 112 also may overcome any latency related issues that may occur such as, for example, delays or packet drops.

In another exemplary implementation, the data packet processing may be implemented using a combination of the processor 102 and the engine 106. After system 100 is powered up, any initial data to and from the network 108 may be routed through the engine 106 to the processor 102 to allow the initial data traffic (e.g., WAN or LAN traffic) to first be handled by the processor 102. Once the processor 102 has identified data flows that can be processed by the engine 106, the processor 102 configures the engine 106 with the information that the engine 106 can use to take over the data packet processing functions.

For instance, these data packet processing functions may include bridging, forwarding and/or packet modification and/or network address translation (NAT) functions of the identified flows. Once the engine 106 has been configured, the processor 102 enables a hand-off allowing the engine 106 to begin processing of the packets at the appropriate time. This flow of the data packet processing allows for an acceleration of the data packet processing because the processing functionality is being offloaded from the processor 102 and handed off to the engine 106. The system 100 may be configured to allow the data packet processing to be adaptable as different types of data packets are processed. Thus, processor 102 may continuously update the tables 114 with modified, updated, or new information so that the engine 106 can continuously adapt to handle new streams of data packets.

The processor 102 may be arranged and configured to inspect and analyze data packets and then apply what the processor 102 has learned about those data packets to other data packet streams. From analyzing the data packets, the processor 102 may learn about the type of connections being made by the data packets and the kinds of modifications that are to be made to the data packets. The processor 102 may log this learned information so that when future data packets are received, the processor 102, the engine 106, and/or the processor 102 in combination with the engine 106 will know how to process and handle the future data packets.

For instance, the processor 102 may be arranged and configured to receive an initial data packet from a data stream, to classify the initial data packet from the data stream and to populate one or more tables 114 with information based on the classification of the initial data packet from the data stream. The initial data packet may include a single data packet from the data stream and/or the initial data packet may include more than just the first data packet from the data stream to include just enough of the initial data packets that may be needed to classify the data packets for this data stream. The engine 106 may be arranged and configured to process subsequent data packets from the data stream using the information present in the tables 114 such that the subsequent data packets from the data stream bypass the processor 102.

The engine 106 may include a hardware engine that may be configurable by the processor 102. The engine 106 may include one or more tables 114 that are configurable and populated with information obtained by the processor 102. The engine may sometimes be referred to as a classification, modification and forwarding (CMF) engine.

In one exemplary implementation, the engine 106 may be implemented in a chip, where the engine 106 uses an area that is less than 5 mm². In one exemplary implementation, the engine 106 may be implemented in a chip, where the engine 106 uses an area that is less than 1 mm².

The tables 114 may be arranged and configured to include tables that are capable of storing different types of data, as described in more detail below. The tables 114 may be scalable. For example, a filter classification table may be scalable by sharing entries across various data flows.

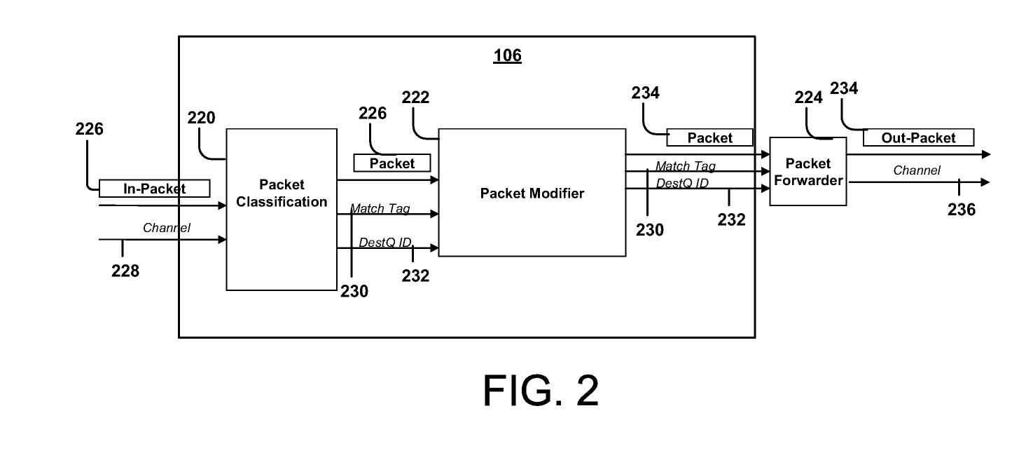

Referring to FIG. 2, the engine 106 includes a packet classifier module 220, a packet modifier module 222, and a packet forwarder module 224. In general, the packet classifier module 220 may receive one or more data packets 226 that are communicated through one or more channels 228. Multiple streams of data packets may be received using the channels 228. In one exemplary implementation, multiple streams of data packets may be received simultaneously using the channels 228.

Data packet 226 may include different types of data including, for example, data, voice over internet protocol (VoIP) data and video data. Some data may be prioritized higher than other data. For example, the VoIP data and video data may have a higher priority than other types of data.

The packet classifier module 220 may inspect the data packet 226 to determine a data packet type and a data packet priority. The packet classifier module 220 may output a match tag 230 and a destination tag 232 (e.g., destination tag DestQ ID) along with the data packet 226. The match tag 230 may represent a high level match processing result of the processing the occurs in the packet classifier module 220. The match tag 230 may represent a best match tag, where the match tag 230 is communicated to the packet modifier module 222 for further refinement matching or matching at a finer granularity for a more specific match. The destination tag 232 may be a tag that represents a desired destination and may be used to prioritize the data packet.

The packet classifier module 220 also may output other information. For example, the packet classifier module 220 may output a packet length. The packet length information may be used either alone or in conjunction with other information (e.g., the match tag 230 and/or the destination tag 232) in differentiated services code point (DSCP)/quality of service (QOS) metering and DontFragment handling. A priority may be assigned to the packet based on one or more criteria. The priority may be assigned by the packet classifier module 220 or by a pre-classifier.

The packet modifier module 222 may receive the data packet 226, the match tag 230 and the destination tag 232. The packet modifier module 222 may be arranged and configured to parse the data packet header, to compare the data packet against one or more configurable tables and to modify the data packet 226 accordingly. The packet modifier module 222 may output a modified data packet 234, the match tag 230 and the destination tag 232 to the packet forwarder module 224.

The packet forwarder module 224 may receive the modified data packet 234, the match tag 230 and the destination tag 232 from the packet modifier module 222. The packet forwarder 224 may be arranged and configured to output and forward the modified data packet 234 using one or more communication channels 236. One of the communication channels 236 may include a direct hardware forwarding path. The direct hardware forwarding path may be a dedicated hardware path between the engine 106 and another component in the system, such that the other component in the system may receive the modified data packet 234 directly without further processing of the modified data packet 234 by any other processing component. The packet forwarder module 224 may forward the modified data packet 234 using the direct hardware forwarding path such that the modified data packet 234 may bypass the processor 102 of FIG. 1.

In one exemplary implementation, the packet forwarder module 224 also may route data packets identified as having a high priority to one or more destinations. For example, the processor 102 may include one or more priority queues. The packet forwarder module 224 may route modified data packets 234 identified as having a higher priority to one or the processor 102 priority queues.

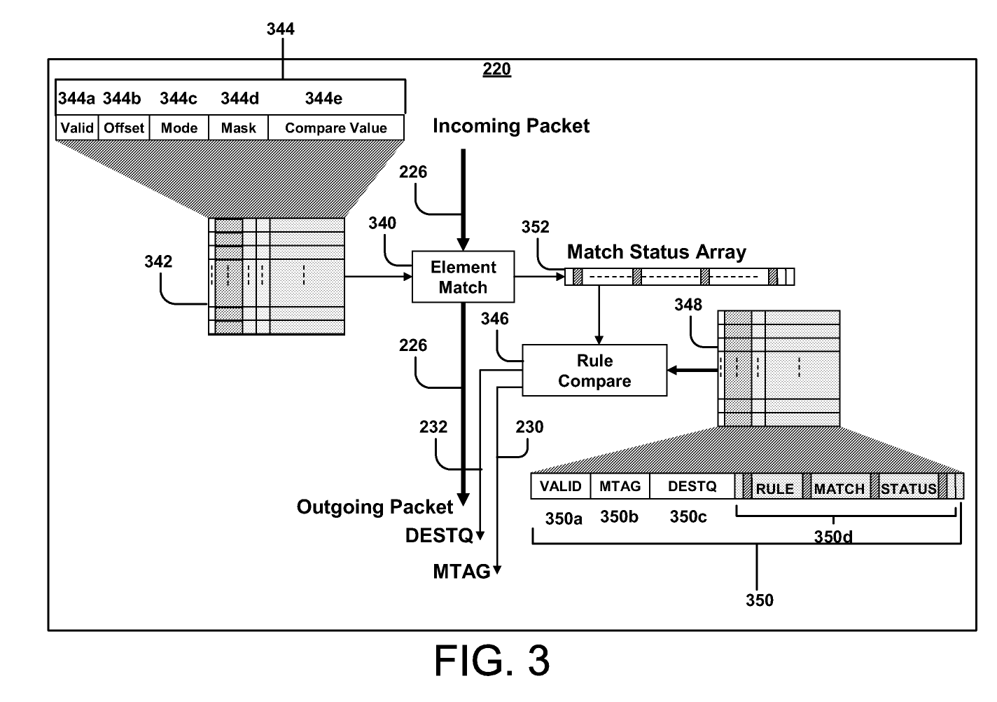

Referring to FIG. 3, the packet classifier module 220 is illustrated in more detail. The packet classifier module 220 may include an element match module 340 that includes an element table 342 and a rule compare module 346 that includes a rule table 348. The packet classifier module 220 may provide for inspection of an incoming data packet 226 and tagging of the data packet when matching specified inspection “rules.”

The packet classifier module 220 may be configured to inspect data packet headers that may be present in different layers. For example, the packet classifier module 220 may be configured to inspect any Layer 2, Layer 3, or Layer 4 data packet header information and, on compare match, tag the data packet with a configurable match tag 230 and/or destination tag 232. Layer 2 compare criteria may include VLAN ID, 802.1Q priority and/or source/destination medium access control (MAC) address. Layer 3 compare criteria may include a protocol type (e.g., internet protocol (IP), user datagram protocol (UDP), transmission control protocol (TCP), or other protocols), source address (SA), destination address (DA), and/or port number. Layer 4 compare criteria may include port numbers. The packet classifier module 220 may support both Internet Protocol version 4 (IPv4) and Internet Protocol version 6 (IPv6).

Multiple field compares may be accomplished by combining multiple 2-byte inspection elements, which when applied to 16-bit words at offsets within the first 96 bytes or the first 256 bytes of the data packet may form an inspection rule. Multiple inspection rules may be supported. In one exemplary implementation, up to 64 inspection rules are supported.

The packet classifier module 220 also may match on out of band information. For example, if the system includes an asynchronous transfer mode (ATM) segmentation and reassembly (SAR) module, then the packet classifier module 220 may match on out of band information such as the virtual channel identifier (VCID) for data arriving from the ATM SAR. If the system includes an Ethernet switch, then the packet classifier module 220 may match on a physical port number for the data arriving from the Ethernet switch. Using the packet classifier module 220, it may be possible to attach classification match tags 230 to a wide variety of packet types. For example, specific PPPoE sessions may be tagged, specific traffic that is to be bridged on a VLAN may be tagged, or specific packets that are to be network address translated may be tagged.

The element match module 340 may include an element table 342 with one or more distinct fields. The element match module 340 and the element table 342 may include an inspection rule that may include a number of inspection elements 344. For example, the element table 342 fields may include a valid element field 344a specifying whether or not the inspection element is valid, an offset field 344b specifying which 16-bit word offset of the data packet to apply to the element, a compare mode field 344c specifying which compare operation to perform (e.g., test equal, all bits set, all bits clear, and/or some bits set and some bits cleared), a nibble mask field 344d specifying which compare operation to perform in conjunction with the compare mode field 344c and a 2-byte compare value field 344e specifying which 16-bit word value to use in the comparison.

Using the rule compare module 346 and the rule table 348, the packet classifier module 220 may support multiple inspection rules. In one exemplary implementation, up to 64 inspection rules may be supported. Each inspection rule may apply a subset of 128 available inspection elements to packet header fields, including for example, IP, TCP/UDP, PPP, MAC DA/SA, and VLAN fields) and may result in a unique classification match tag 230 and destination tag 232 that get appended to the data packet 226 on a “Rule Hit.” A “Rule Miss” may result in the appending of a default match tag 230 and destination tag 232 that may be based on other default settings, such as, for example, a VCID default setting in an ATM SAR or PortID default setting in a switch.

Inspection elements that may be common across multiple rules may be re-used by each of the rules. For example, it may be desirable to assign different match values to VoIP data packets destined for different destinations. For a given set of VoIP data packets, the protocol type may be at the same data packet offset and thus, the protocol type inspection element may be in common for all the VoIP packet rules. The rules may differ in the inspection elements required to uniquely identify the destinations. The match tag 230 also may be communicated to the processor 102 for any non-hardware forwarded data packet and may be used to accelerate data packet processing by the processor 102 (e.g., software data packet processing).

Data packet 226 may be received by the element match module 340. In one exemplary implementation, as the first 2-bytes of the data packet 226 are received, all inspection elements from the element table 342 with an offset of 0 are applied. If the element command mode field 344c is test equal and all 4 bits of the nibble mask field 344d are one (e.g., enable compare for respective nibbles), then the input bytes must exactly match the element compare value field 344e. If they do match, the bit corresponding to that matched inspection element is set in the match status array 352. The match status array 352 may be reset at the start of an incoming data packet 226, so that it may hold the element match information for the current data packet.

Once the end of packet (EOP) is detected, or the fixed search depth, or the configured maximum depth words of the data packet have been inspected, the resulting match status array 352 is compared to each entry in the rule table 348 using the rule compare module 346. In one exemplary implementation, the rule compare module 346 also may conditionally compare the input VCID (e.g., from an ATM SAR) or PortID (e.g., from a switch) to the VCID/PortID field of each inspection rule. If the result of these compares indicates a “Rule Hit”, then the associated match tag 230 and the destination tag 232 are sent to the packet modifier module 222. VCID (or PortID) defaults may be used when no rule is hit. The rule table 348 may be searched in order.

The rule table 348 may include multiple inspection rules that may be used to identify a particular data packet, a specific data packet flow, an application type, a protocol type and/or other information. The rule table 348 may include multiple fields 350. For instance, in one exemplary implementation, the multiple fields 350 may include a valid field 350a specifying whether or not the inspection rule is valid, a match tag field 350b specifying the value to pass on to the packet modifier module upon a “Rule Hit”, a destination tag field 350c specifying a target destination, and an element match field 350d specifying which inspection elements are used to comprise the rule.

The element table 342 and the rule table 348 may be populated with information from the processor 102. The information from the processor may be obtained during the inspection of an initial flow of data packets or the first streams of data packets.

Depending on how each inspection element is configured, it is possible for multiple inspection elements to result in valid matches for the same incoming data offset. This feature may be used to overlap inspection elements to target specific bytes in a data packet. For example, inspection elements can take advantage of the nibble mask field 344d and the compare mode field 344c to set up unique operations for the same offset location in a data packet. Rule hits and misses may be kept track of in the match status array 352.

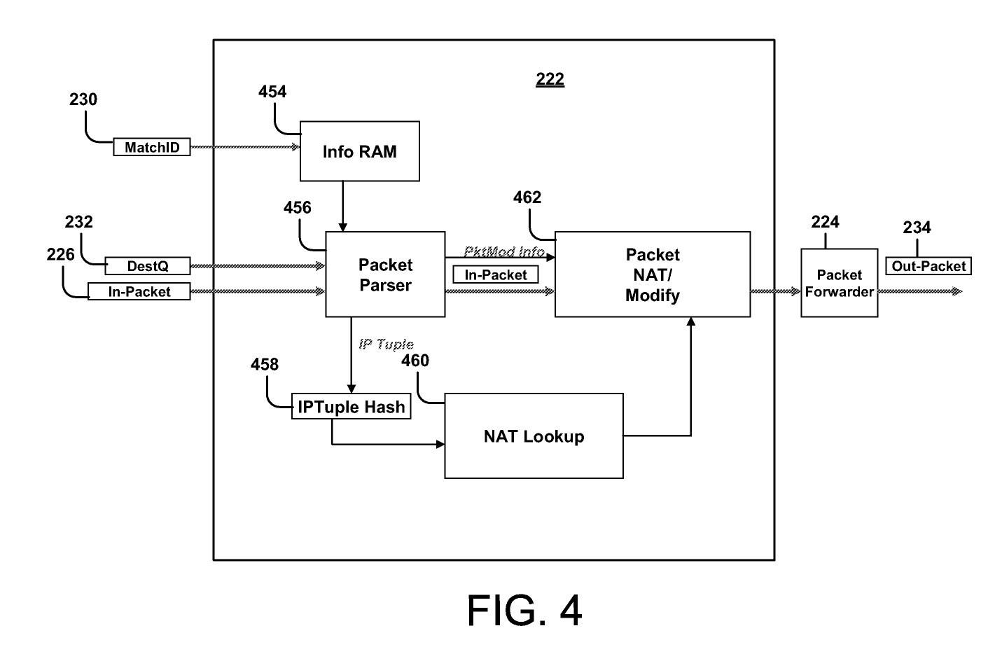

Referring to FIG. 4, the packet modifier module 222 is illustrated in more detail. The packet modifier module 222 may include an Info RAM module 454, a packet parser module 456, an IPTuple hash module 458, a NAT lookup module 460 and a packet NAT/modify module 462. The data packet 226, the match tag 230 and the destination tag 232 are received by the packet modifier module 222 from the packet classifier module 220. More specifically, the data packet 226 and the destination tag 232 may be received by the packet parser module 456 and the match tag 230 may be received by the Info RAM module 454.

In general, the packet modifier module 222 may receive the incoming data packet 226, parse the packet header and apply a set of packet modification rules to modify the packet as specified and then route or re-route the modified data packet 234 to a specified destination. Using these modification rules, the packet modifier module 222 may provide a hardware NAT and forwarding function that may include MAC address modification, IP destination address (DA), source address (SA) and TCP/UDP port modification along with time to live (TTL) decrement and IP/TCP/UDP checksum recalculation. The packet modifier module 222 also may remove or insert any number of bytes from the packet header.

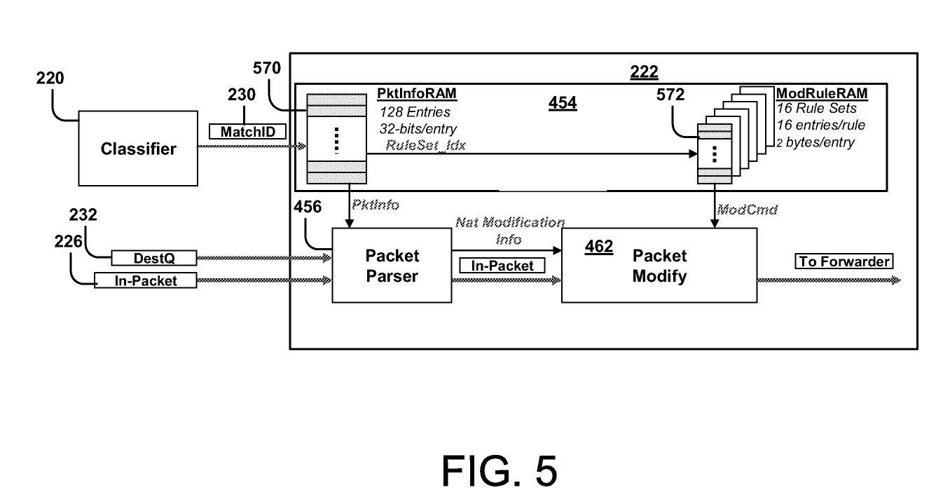

The match tag 230 may be used by the Info RAM module 454 to index an entry in one or more tables in the Info RAM module 454. Referring also to FIG. 5, the Info RAM module 454 may include an Info RAM table 570 and a ModRule table 572. The Info RAM table 570 may be arranged and configured to receive the match tag 230.

For example, an Info RAM table 570 may contain information related to the desired processing of the data packet 226. The values stored in this table provide the packet modifier module 222 with additional information about the data packet, including IP header start location and TCP/UDP port field start location. The Info RAM table 570 also may include information on how the data packet should be handled including which packet modification rule set to apply (if any), when to apply the packet modification rule set, whether or not the data packet should be redirected to a new destination direct memory access (DMA) channel and whether or not the data packet should have an Ethernet MAC header inserted. A field of this table may be used to provide processor-to-hardware hand-off of data packet processing.

The Info RAM table 570 may include multiple entries with multiple bits per each entry. In one exemplary implementation, the Info RAM table 570 may include 128 entries with 32 bits per entry. For example, the Info RAM table 570 may contain information including information related to: a hold of any packets from a specific data packet flow until the processor has emptied its receive buffers and cleared a stall enable bit; packet modification/NAT enable; modification rule set selection and when to apply a rule (e.g., on NAT hit, on NAT miss, always, never, drop a packet); Ethernet MAC header insertion or replacement enable; IP header start location (e.g., of the incoming data packet); and/or destination redirect which can conditionally remap the input destination tag and when to apply redirect (e.g., on NAT hit, on NAT miss, always, never). The Info RAM table 570 also may be configured to force the drop of all packets belonging to a particular data stream under certain condition.

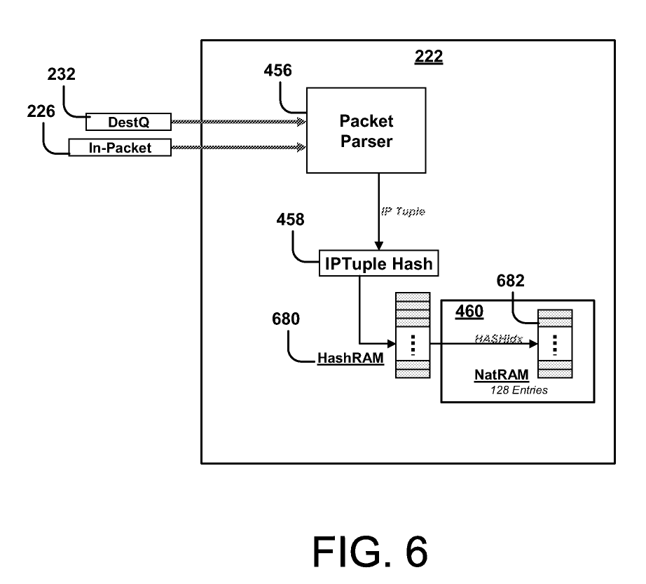

The Info RAM table 570 may output a rule index (e.g., RuleSet_Idx) that is used by the Mod Rule table 572. The Info RAM table 570 also outputs packet information (e.g., PktInfo) to the packet parser module 456. Referring also to FIG. 6, in one exemplary implementation, the rule index (e.g., RuleSet_Idx) also may be defined and/or modified by a Nat hit or a NAT miss. The rule index (e.g., RuleSet_Idx) also may be identified by the NatRAM 460 on a Nat hit or on a Nat miss.

Referring also to FIG. 6, the packet parser module 456 receives the packet information from the Info RAM table 570 in the Info RAM module 454. The packet parser module 456 may use this packet information to create an index into the IPTuple hash module 458 by calculating a hash value of the input IP Tuple. The IP Tuple may include the SA, DA, source port, destination port and protocol. The packet parser module 456 may use packet information (e.g., the IP offset) from the Info RAM table 570 to determine the IP Tuple. The packet parser module 456 may build a hash of the IP Tuple using a 16 bit cyclic redundancy check (CRC). The hash value may be used as an index into a hash table (e.g., HashRAM table 680) which then indexes into the NatRAM table 682, which may be located in the NAT lookup module 460. Each entry in the NatRAM table 682 may be linked with a field pointing to the next entry in this list.

A HashRAM table 680 includes an indexed location that then provides an index into the multiple entry (e.g., 128 entry) NatRAM table 682. The HashRAM table 680 may include multiple indexes to specific NatRAM table 682 locations. For example, the multiple byte IP Tuple that is communicated from the packet parser module 456 may be hashed to a value that is the pointer into the HashRAM table 680 containing a pointer to the NatRAM table 682, which may contain the original and modified IP header information.

The NAT lookup module 460 may include the NatRAM table 682. The NatRAM table 682 may include information that may be used for packet modification processing. The NatRAM table 682 may be used to store information about the incoming expected data packet (e.g., the incoming expected data packet associated with one of the multiple input flows) and the modified outgoing data packet. The NatRAM table 682 may be indexed by the NatRAM index value stored in the HashRAM table 680 at the location calculated by applying a hash algorithm to the input data packet IP Tuple. In one exemplary implementation, the NatRAM table 682 may include 128 entries, with each entry including 32 bytes of data.

The NatRAM table 682 may include, for example, the following information: expected input data packet IP SA, IP DA, source port, destination port, and IP protocol. These values may be compared against the input data packet to ensure that the correct NatRAM table 682 entry was hashed. A match of these values may result in a NAT hit. The NatRAM table 682 also may include a new IP SA, IP DA, source port, and destination port, which may be used in the data packet modification process if an entry from the Info RAM table 570 is set. The NatRAM table 682 also may include new IP and TCP/UDP check sum modification values, which may contain information required for header checksum recalculation when an IP header modification bit is set. The NatRAM table 682 also may include MAC SA and DA indexes into a table that may contain new MAC SA and DA values for use when Ethernet header modification or Ethernet header insertion is enabled. The NatRAM table 682 also may include an index to the next NatRAM location to be used in case the NAT hit fails, which may indicate that the hash value calculation resulted in duplicate hash values for different IP Tuples.

In one exemplary implementation, the processor 102 of FIG. 1 may be configured to populate the HashRAM table 680 and the NatRAM table 682 with a new data packet stream flow. The processor 102 may be configured to select an unused entry in the NatRAM table 682 and configure the fields. The processor 102 may be configured to then apply a hash algorithm to an expected IP Tuple for the new data packet stream flow. The result of the Hash algorithm may be the pointer to the HashRAM location that stores the index to the NatRAM table 682 entry.

The ModRule table 572 may identify rules that can be applied to the data packet. In one exemplary implementation, the ModRule table 572 may identify up to 16 rules that can be applied to the data packet, in addition to IP header, SA, DA, Source/Destination Port modification and/or Ethernet MAC header modification/insertion, which may be enabled separately from the ModRule command set. The ModRule table 572 may contain up to 16 rules, each of which can replace, insert or delete bytes, half words or double words at a specified offset within the bytes of the header. Rules also may be used to provide header checksum updates based on input values from the NatRAM table 682. The ModRule table 572 may output a ModRule command (e.g., ModCmd) to the packet NAT/modify module 462.

In one exemplary implementation, the rules may be divided into multiple groups that may be chained together. For example, the rules may be divided into two groups of 8 that can be applied as separate groups or can be applied with the groups chained together. In this manner, the system is scalable in that it may be able to handle more data flows because the rules are broken down into smaller groups. For a data flow that may need a larger set of rules, then one or more groups of rules may be chained together.

The packet NAT/modify module 462 may receive inputs from the packet parser module 456 and the NAT lookup module 460. The packet NAT/modify module 462 may take the received inputs and apply the selected NAT, Ethernet and ModRule commands identified for the data packet. The modified data packet is output from the packet NAT/modify module 462 to the packet forwarder module 224.

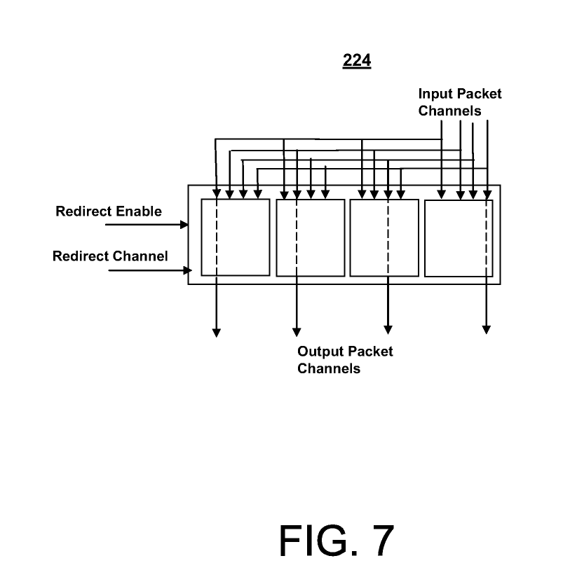

Referring to FIG. 2 and FIG. 7, the packet forwarder module 224 receives the modified data packet 234, the match tag 230 and the destination tag 232. The packet forwarder module 224 may be arranged and configured to route the modified data packet 234 to the designated destination. In one exemplary implementation, the rule selection and forwarding decisions may be made after the layer 3 match and hence in the NatRAM 460.

In one exemplary implementation, the packet forwarder module 224 may process multiple channels simultaneously. For example, the packet forwarder module 224 may process four Ethernet channels simultaneously. The packet forwarder module 224 may redirect data packets from one channel to another channel based on the configuration of the Info RAM module 454.

In one exemplary implementation, data packets may always be redirected, on NAT hit or on NAT miss. For example, channel 1 may include processor traffic and channel 2 may include WAN traffic. If a data packet has a NAT hit on channel 1, the data packet can be redirected directly to channel 2 and avoid processing by the processor.

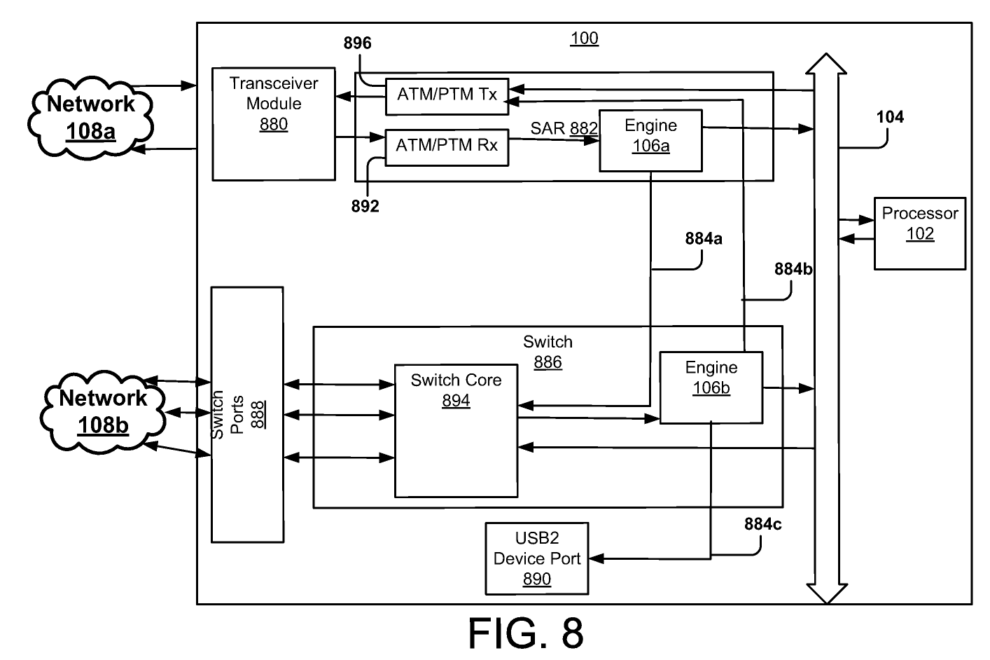

Referring to FIG. 8, an exemplary implementation of system 100 is illustrated. In this exemplary implementation, system 100 may include a DSL transceiver 880, a SAR module 882, a bus 104, a processor 102, direct hardware forwarding paths 884a, 884b and 884c, a switch module 886, switch ports 888, and a USB2 device port 890. System 100 includes multiple engines 106a and 106b, with one engine 106a being located in the SAR module 882 to process downstream data packets from network 108a (e.g., a WAN) and the other engine 106b being located in the switch module 886 to process data packets from network 108b (e.g., LAN ingress data packets). Channels that communicate the data packets to and from system 100 and within system 100 may include multiple channels and communications paths.

The DSL transceiver 880 may include any type of DSL transceiver including a VDSL transceiver and/or an ADSL 2+ transceiver. In other exemplary implementations, the DSL transceiver may alternatively be a modem, such as, for example, a cable modem. The DSL transceiver 880 communicates data packets with network 108a. The DSL transceiver 880 may transmit and receive data packets to and from the network 108a.

When data packets are received from the network 108a, the DSL transceiver 880 communicates the received data packets to the SAR module 882. The SAR module 882 includes an ATM/PTM receiver 892 that is configured to receive the incoming data packets. The ATM/PTM receiver 892 then communicates the incoming data packets to the engine 106a.

Engine 106a may be referred to as a classification, modification and forwarding (CMF) engine. Engine 106a enables the classification, modification and hardware routing of data packets received from the network 108a. Engine 106a may be configured and arranged to operate as described above with respect to engine 106 of FIGS. 1 and 2 and as more specifically described and illustrated with respect to FIGS. 3-7. When data packet processing has been handed-off from the processor 102 to the engine 106a, then engine 106a may process the data packets and output modified data packets directly to switch 886 using the direct hardware forwarding path 884a.

Switch 888 includes engine 106b and switch core 894. Data packets that have been processed and modified by engine 106a may be received at the switch core 894 using the direct hardware forwarding path 884a. The switch core 894 directs the modified data packets to the appropriate switch port 888. Switch port 888 communicates the modified data packets to the network 108b.

When data packets are received from network 108b, they may be received on switch ports 888. Switch ports 888 may includes multiple ports that are wired and/or wireless ports. In one exemplary implementation, the switch ports 888 may include one or more 10/100 Ethernet ports and/or one or more gigabyte interface ports. Switch ports 888 communicate the data packets to switch 886.

More specifically, switch ports 888 communicate the data packet to switch core 894. In one exemplary implementation, switch core 894 may include a gigabyte Ethernet (Gig-E) switch core. Switch core 894 communicates the data packets to engine 106b.

Engine 106b may be referred to as a classification, modification and forwarding (CMF) engine. Engine 106b enables the classification, modification and hardware routing of data packets received from the network 108b. Engine 106b may be configured and arranged to operate as described above with respect to engine 106 of FIGS. 1 and 2 and as more specifically described and illustrated with respect to FIGS. 3-7. When data packet processing has been handed-off from the processor 102 to the engine 106b, then engine 106b may process the data packets and output modified data packets directly to SAR module 882 using the direct hardware forwarding path 884b or to USB2 device port 890 using the direct hardware forwarding path 884c.

When the modified data packets are received by the SAR module 882, the modified data packets are communicated to an ATM/PTM transmit module 896. The ATM/PTM transmit module 896 then communicates the modified data packets to the DSL transceiver module 880, which then communicates the modified data packets to the network 108a.

Initial processing of data packets may be performed by processor 102. Incoming data packets may be received from network 108a and/or 108b and communicated either through the SAR module 882 and engine 106a or switch 886 and engine 106b to the processor 102 using bus 104. Processor 102 may be arranged and configured to process the data packets in a manner similar to engines 106a and 106b such that data packets are accelerated through the system 100. Additionally, processor 102 may be arranged and configured to populate one or more tables with information from and related to the initial data packet flow such that the data packet processing may be handed off from the processor 102 to the engines 106a and 106b. The engines 106a and 106b use the information in the populated tables to process the data packets and output modified data packets using the direct hardware forwarding paths 884a, 884b and 884c such that the bus 104 and the processor 102 are bypassed.

In one exemplary implementation, the processor 102 may include one or more processor priority queues that may be arranged and configured to handle priority data packet flows. In some implementations, the engines 106a and 106b may process the data packets and then communicate priority data packets that may use the processor 102 in a priority manner. This may enable the prioritization of services such as voice and video. The destination tag 232 described above with respect to FIGS. 2-6 may be used to identify priority data packets.

In one exemplary implementation, the engines 106a and 106b are each capable of handling greater than 1 million data packets/second at aggregate rates up to 1.5 Gbps.

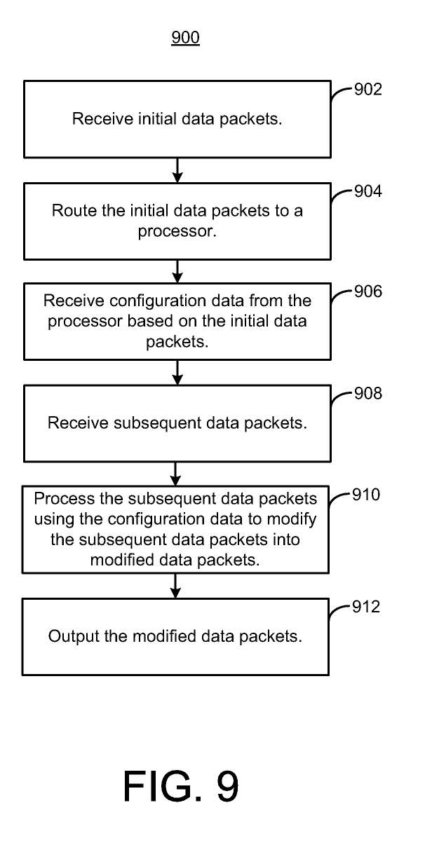

Referring to FIG. 9, a process 900 may be used to process data packets. Process 900 includes receiving initial data packets (902), routing the initial data packets to a processor (904) and receiving configuration data from the processor based on the initial data packets (906). Process 900 also may include receiving subsequent data packets (908), processing the subsequent data packets using the configuration data to modify the subsequent data packets into modified data packets (910) and outputting the modified data packets (912).

In one exemplary implementation, process 900 may be implemented by engine 106 of FIG. 1 and as described in more detail in FIGS. 2-7. Engine 106 may be arranged and configured to be a hardware engine. For example, the initial data packets may be received (902) from a network 108 at engine 106. The initial data packets may be routed (904) by engine 106 routing the initial data packets using bridge 104 to processor 102.

Configuration data may be received from the processor 102 based on the initial data packets (906) by the engine 106. For example, the configuration data may be used to populate one or more tables 114. More specifically, for example, the configuration data may be used to populate element table 342, rule table 348, Info RAM table 570, ModRule table 572, HashRAM table 680, NatRAM table 682, and/or any other tables that may be used in the engine 106 or the processor 102.

Once configuration data has been received from the processor 102 (906), then subsequent data packets may be received (908). For example, subsequent data packets may be received (908) from a network 108 at engine 106.

The subsequent data packets may be processed using the configuration data to modify the subsequent data packets into modified data packets (910). For example, the engine 106 may process and modified the subsequent data packets. The engine 106 may use the packet classifier module 220, the packet modifier module 222 and/or the packet forwarder module 226 to process the subsequent data packets. The packet modifier module 222 may output modified data packets to the packet forwarder engine 226. The packet forwarder engine 226 may output the modified data packets to an appropriate destination (912).

In one exemplary implementation, the subsequent data packets may be processed and output by the engine 106 to a direct hardware path. For instance, the engine 106a of FIG. 8 may output modified data packets to switch 886 using direct hardware forwarding path 884a, thus enabling the modified data packets to bypass the processor 102. Similarly, the engine 106b of FIG. 8 may output modified data packets to SAR module 882 using the direct hardware forwarding path 884b, thus enabling the modified data packets to bypass the processor 102.

Process 900 may result in an offload of data packet processing from the processor 102 such that the data packet processing may be accelerated by using the engine 106 to process the subsequent data packets. A system using this process 900, such as, for example, system 100, may realize increased throughput of data packets that are routed to any one of multiple destinations including using dedicated hardware paths. Using process 900 may free up a system bus, such as bus 104, and may also reduce memory bandwidth. In one exemplary implementation, packet throughput may be increased up to and including 1.5 Gbps.

In one exemplary implementation, the subsequent data packets that are processed by the engine 106 may need to be sent to the processor 102 for more complex modifications. For example, the engine 106 may process the subsequent data packets and identify the match tag and the destination tag and modified the packets as appropriate. However, once engine 106 has completed its handling of the data packets, the data packets may be sent to the processor 102 for additional processing. For instance, the data packets may need to be run through an encryption process and the processor 102 may be arranged and configured to handle the additional encryption processing. So, once the engine 106 has completed handling the data packets, then the processor 102 may receive the data packets and perform the encryption processing. The packet forwarder 224 may be arranged and configured to forward the packets to the processor 102 for the additional processing.

The use of multiple different tables throughout the system enables the system to be highly scalable. The entries in the multiple different tables may be shared by multiple different data flows that are processed through the system. The arrangement and configuration of the multiple different tables, where the data entries may be shared by multiple data flows may be achieved at a lower cost and on a smaller area of the chip than other types of implementations.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system comprising:
a processor that is arranged and configured to receive an initial data packet from a data stream, to classify the initial data packet from the data stream and to populate one or more tables with information based on the classification of the initial data packet from the data stream;
a bus in communication with the processor; and
an engine, in communication with the bus, that is arranged and configured to process subsequent packets from the data stream using the information present in the one or more tables such that the subsequent data packets from the data stream bypass the processor.

2. The system of claim 1 further comprising an operating system that includes a data packet processing stack wherein the processor is configured and arranged to process the subsequent data packets such that the subsequent data packets bypass the data packet processing stack.

3. The system of claim 1 wherein the processor is arranged and configured to inspect the initial data packets from the data stream and to determine a data packet type and a data packet priority and to populate the one or more tables with the information related to the data packet type and the data packet priority including a match tag and a destination tag.

4. The system of claim 1 wherein the engine comprises a packet classifier module that is arranged and configured to determine a data packet type and a data packet priority.

5. The system of claim 1 wherein the engine comprises a packet modifier module that is arranged and configured to parse a data packet header, to compare the data packet header against the one or more tables and to modify the data packet header.

6. The system of claim 1 wherein the engine includes a packet forwarder module that is arranged and configured to forward the subsequent data packets to a direct hardware forwarding path such that the subsequent data packet bypasses the processor.

7. The system of claim 1 wherein the engine includes a packet forwarder module that is arranged and configured to forward the subsequent data packets to the processor for additional processing.

8. The system of claim 1 wherein the engine is a hardware engine.

9. The system of claim 1 further comprising a segment and reassembly module (SAR) module, wherein the engine resides in the SAR module.

10. The system of claim 1 further comprising a switch module, wherein the engine resides in the switch module.

11. The system of claim 1 wherein the engine is configured to use an area on a chip, the area being less than 1 mm².

12. The system of claim 1 wherein the engine comprises:
a packet classifier module that is arranged and configured to receive the subsequent data packets, to inspect the subsequent data packets and to output a match tag and a destination tag;
a packet modifier module that is arranged and configured to receive the match tag and the destination tag, to parse headers of the subsequent data packets and to use the match tag and the destination tag to apply header modification rules to the subsequent data packets to output modified data packets; and
a packet forwarder module that is configured and arranged to direct the modified data packets to a direct hardware forwarding path.

13. A system, comprising:
a segmentation and reassembly (SAR) module that includes a first classification, modification and forwarding (CMF) engine;
a switch module that includes a second CMF engine;
a direct hardware forwarding path that directly connects the SAR module to the switch module;
a processor; and
a bus that connects the processor to the SAR module and the switch module.

14. The system of claim 13 wherein the SAR module, the switch module, the direct hardware forwarding path, the processor, and the bus are configured on a chip that has a size of less than 1 mm².

15. The system of claim 13 wherein:
the first CMF engine and the second CMF engine route initial data packets across the bus to the processor; and
the processor is arranged and configured to process the initial data packets and to configure the first CMF engine and the second CMF engine with information to enable first CMF engine and the second CMF engine to process subsequent data packets.

16. The system of claim 15 wherein the first CMF engine is arranged and configured to process the subsequent data packets and to forward the subsequent data packets to the switch module using the direct hardware forwarding path.

17. The system of claim 15 wherein the second CMF engine is arranged and configured to process the subsequent data packets and to forward the subsequent data packets to the SAR module using the direct hardware forwarding path.

18. The system of claim 13 wherein the first CMF engine is arranged and configured to provide network address translation.

19. A method, comprising:
receiving initial data packets;
routing the initial data packets to a processor;
receiving configuration data from the processor based on the initial data packets;
receiving subsequent data packets;
processing the subsequent data packets using the configuration data to modify the subsequent data packets into modified data packets; and
outputting the modified data packets.

20. The method as in claim 19 wherein outputting the modified data packets includes outputting the modified data packets to a direct hardware path.
